(19) United States
(12) Patent Application Publication
(10) Pub. No.: US 2026/0299615 A1
(43) Pub. Date: Oct. 1, 2026

(54) CONTROL METHOD OF MOBILE BODY, CONTROL DEVICE, MOBILE BODY, AND STORAGE MEDIUM

(71) Applicant: HONDA MOTOR CO., LTD., Tokyo (JP)

(72) Inventors: Akane AIZAWA, Wako-shi (JP); Sango MATSUZAKI, Wako-shi (JP)

(21) Appl. No.: 19/629,999

(22) Filed: Mar. 26, 2026

(30) Foreign Application Priority Data
Mar. 31, 2025 (JP) 2025-058999

(51) Int. Cl. G05D 1/686

(52) U.S. Cl. CPC G05D 1/686

(57) ABSTRACT

A control method of a mobile body that autonomously moves together with a specific person is disclosed. The control method includes recognizing an accompanying state of the specific person with respect to the mobile body using an image obtained by capturing surroundings of the mobile body, determining whether the accompanying state of the specific person is a predetermined state that is an appropriate state, and outputting a request for behavior of the specific person to bring the accompanying state of the specific person into the appropriate state when it is determined that the accompanying state of the specific person is not the appropriate state.

### CROSS-REFERENCE TO RELATED APPLICATION(S)

This application claims priority to and the benefit of Japanese Patent Application No. 2025-058999, filed Mar. 31, 2025, the entire disclosure of which is incorporated herein by reference.

### BACKGROUND OF THE INVENTION

### Field of the Invention

The present disclosure relates to a control method of a mobile body, a control device, a mobile body, and a storage medium.

### Description of the Related Art

There is a known mobile body that follows or leads a user (also referred to as a specific person) and autonomously travels, such as a robot. Japanese Patent Laid-Open No. 2023-151177 discloses a technique of uttering or displaying information on a specific store in a case where a behavior prediction result for a specific person is entering a specific store region in a mobile body that travels in front of the specific person while performing behavior prediction for the specific person.

Meanwhile, in a case where the mobile body moves together with the specific person, an interval between the mobile body and the specific person may be kept constant. However, the interval may not be kept constant, for example, in a case where the relative speed of the specific person who travels ahead in hurry is fast relative to the mobile body. As a result, the interval between the specific person traveling ahead and the following mobile body may be increased, or the specific person behind may approach the mobile body traveling ahead. When such a situation occurs, the specific person may feel uncomfortable, or adverse effects such as a decrease in safety may occur.

### SUMMARY OF THE INVENTION

The present disclosure has been made in view of the above problems, and an object thereof is to provide a technique capable of bringing movement of a mobile body and a specific person into an appropriate state.

According to the present disclosure, a control method of a mobile body that autonomously moves together with a specific person, the control method comprising: recognizing an accompanying state of the specific person with respect to the mobile body using an image obtained by capturing surroundings of the mobile body; determining whether the accompanying state of the specific person is a predetermined state that is an appropriate state; and outputting a request for behavior of the specific person to bring the accompanying state of the specific person into the appropriate state when it is determined that the accompanying state of the specific person is not the appropriate state is provided.

### BRIEF DESCRIPTION OF THE DRAWINGS

FIG. 1 is a perspective view illustrating an overall configuration example of a mobile body of the present embodiment;

FIG. 2 is a schematic plan view for describing an example of a traveling unit of the mobile body of the present embodiment;

FIG. 3 is a block diagram illustrating an example of a control system of the mobile body of the present embodiment;

FIG. 4 is a block diagram illustrating a functional configuration example of a control unit of the present embodiment;

FIG. 5A is a view (1) for describing state optimization of the present embodiment;

FIG. 5B is a view (2) for describing the state optimization of the present embodiment;

FIG. 5C is a view (3) for describing the state optimization of the present embodiment;

FIG. 5D is a view (4) for describing the state optimization of the present embodiment;

FIG. 5E is a view (5) for describing the state optimization of the present embodiment; and

FIG. 6 is a flowchart illustrating a series of operations of intention acquisition processing of the present embodiment.

### DESCRIPTION OF THE EMBODIMENTS

Hereinafter, embodiments will be described in detail with reference to the attached drawings. Note, the following embodiments are not intended to limit the scope of the disclosure, and limitation is not made to a disclosure that requires a combination of all features described in the embodiments. Two or more of the multiple features described in the embodiments may be combined as appropriate. Furthermore, the same reference numerals are given to the same or similar configurations, and redundant description thereof is omitted.

### Embodiment

In the following embodiment, a case of using a micro mobility vehicle as an example of a mobile body will be described as an example. The micro mobility vehicle is, for example, a small-sized electric vehicle that allows loading of baggage and follows a user (also referred to as a specific person) or leads or guides the user. However, the present embodiment may be applied not only to a case of loading baggage but also to a vehicle on which a person can ride, or may be applied not only to the vehicle but also to an autonomously movable robot. For example, the application to a robot, capable of autonomously walking using legs without having wheels, is also possible. In addition, in the following description, a mobile body including one driven wheel will be described as an example, but the mobile body does not necessarily include the driven wheel. Further, the number of the driven wheels is not limited to one, and may be two or more. The present embodiment is applicable not only to a case where the mobile body is electrically driven, but also to a mobile body that moves by other power.

### Configuration of Mobile Body

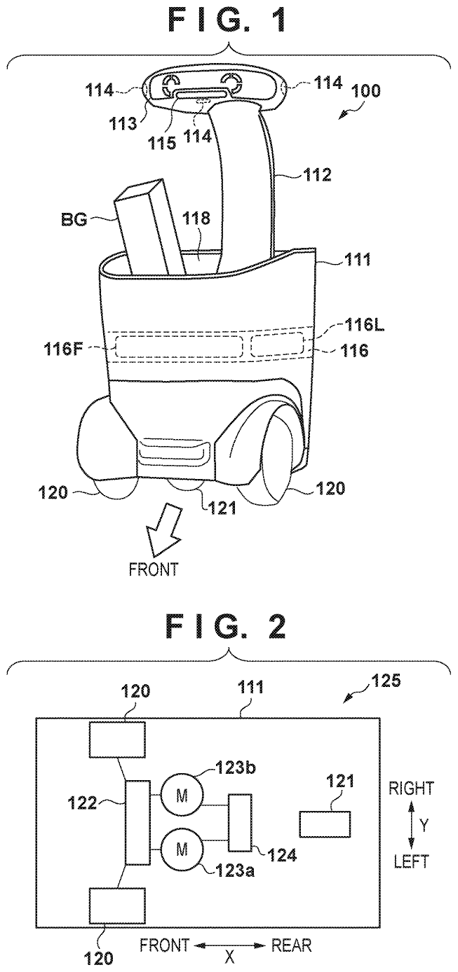

A configuration of a mobile body 100 according to the present embodiment will be described with reference to FIG. 1. FIG. 1 is a perspective view illustrating an overall configuration of the mobile body. As illustrated in FIG. 1, the mobile body 100 according to the embodiment includes a lower housing 111, an upper housing 112, a front display unit 113, a plurality of detection units 114, a sound output unit 115, a light emission unit 116, two driving wheels 120, and a driven wheel 121. Note that the side on which the driving wheels 120 are provided will be referred to as the front.

The lower housing 111 rotatably holds the driving wheels 120 and the driven wheel 121, and also accommodates a traveling unit including the driving wheels 120 and the driven wheel 121. An upper portion of the lower housing 111 includes a loading space 118 into which it is possible to load baggage of a user. The lower housing 111 accommodates the light emission unit 116. A region, which accommodates the light emission unit 116, of the lower housing 111 is made of a light-transmissive material.

The upper housing 112 is configured to extend upward from a rear portion of the lower housing 111. The upper housing 112 supports, at an upper end portion, the front display unit 113, the detection units 114, and the sound output unit 115.

The front display unit 113 notifies the user of information using an image. The front display unit 113 may be a display device that displays an image, such as a liquid crystal display device or an organic electro luminescence (EL) display device. The front display unit 113 is provided on the front side of an upper end of the upper housing 112. The front display unit 113 is directed forward. The front display unit 113 notifies the user of information by displaying an image imitating a human eye or face, characters, and the like.

The plurality of detection units 114 detect target objects such as people and objects in the surroundings of the mobile body 100. The detection unit 114 may be an imaging device including an optical system such as a lens, an image sensor, and the like. The detection unit 114 captures an image of the surroundings, and outputs image data. The detection unit 114 may include a device capable of detecting an object, such as a radar and a light detection and ranging (LiDAR), instead of or in addition to the imaging device. The plurality of detection units 114 are respectively provided, for example, on the front, rear, left, and right of the upper end portion of the upper housing 112. This enables the plurality of detection units 114 to capture and generate images of all directions (that is, around 360 degrees) of the mobile body 100. Note that the installation positions and the number of the detection units 114 are not particularly limited, and may be appropriately changed.

The sound output unit 115 notifies surrounding people, such as the user, of information using sound. The sound output unit 115 may be a sound output device such as a speaker.

The light emission unit 116 notifies surrounding people, such as the user, of information using light. The light emission unit 116 includes, for example, a light emitting element such as one or a plurality of light emitting diodes (LEDs). The light emission unit 116 is provided to surround the lower housing 111. The light emission unit 116 may emit a plurality of colors. The light emission unit 116 is capable of emitting light in a different color for every region or direction. That is, for example, the light emission unit 116 emits light in a different color for each of a front region 116F, a left region 116L, and a right region. In addition, the light emission unit 116 can switch between light emission and turning off for each region. As for the region, light emission may be controlled for a more detailed region.

The two driving wheels 120 are provided on the left and right of a front lower portion of the lower housing 111. The driving wheels 120 rotate around an axle by a driving force transmitted from the traveling unit.

The driven wheel 121 is provided at the center of a rear lower portion of the lower housing 111. The driven wheel 121 is turnably held around a vertical axis extending in an up-and-down direction.

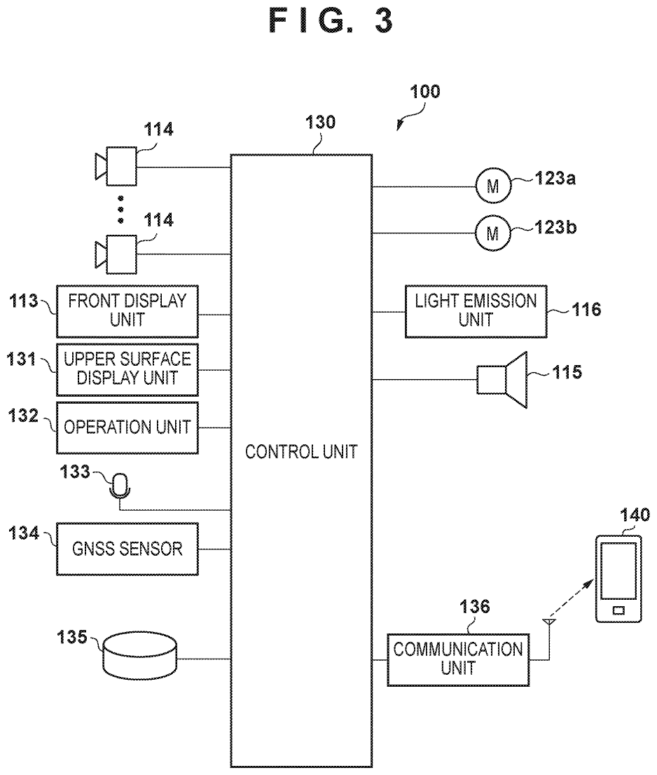

FIG. 2 is a schematic plan view illustrating a traveling unit 125 of the mobile body 100. The traveling unit 125 of the mobile body 100 will be described with reference to FIG. 2.

The traveling unit 125 is provided in a lower portion of the lower housing 111. The traveling unit 125 includes the two driving wheels 120, the driven wheel 121, a drive mechanism 122, a motor 123a, a motor 123b, and a battery 124.

The motor 123a and the motor 123b function as drive sources when electric power is supplied from the battery 124, and supply a driving force to the drive mechanism 122. The drive mechanism 122 transmits the driving force supplied from the motor 123a and the motor 123b to the driving wheels 120. Thus, the drive mechanism 122 rotates the driving wheels 120 to move the mobile body 100 forward or backward. The drive mechanism 122 causes a rotation difference between the motor 123a and the motor 123b to set a traveling direction of the mobile body 100 to either the left or the right. The drive mechanism 122 changes the magnitude of the rotation difference to achieve various turns of the mobile body 100 such as a pivot turn, a slow turn, and a spin turn.

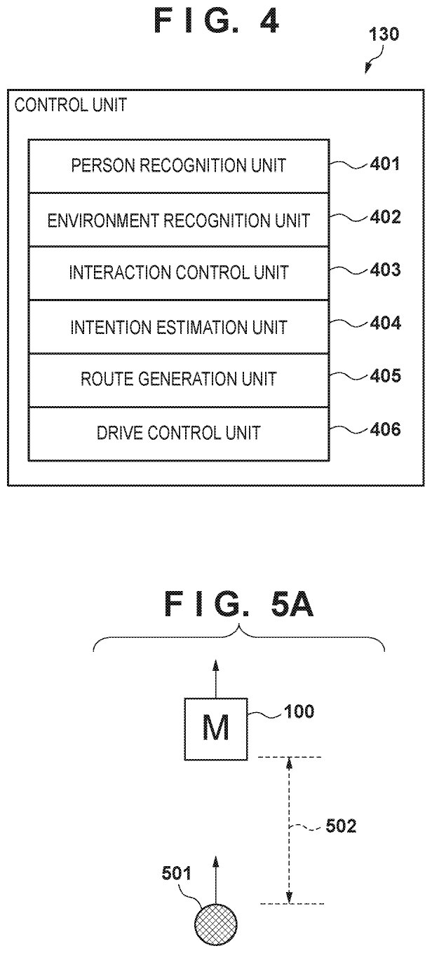

FIG. 3 is a block diagram of a control system of the mobile body 100. The control system of the mobile body 100 will be described with reference to FIG. 3. As illustrated in FIG. 3, the mobile body 100 further includes a control unit 130, an operation unit 132, an upper surface display unit 131, a sound input unit 133, a GNSS sensor 134, a storage device 135, and a communication unit 136.

The control unit 130 is an example of a control device, is also called an electronic control unit (ECU), and may be a computer. The control unit 130 conducts overall control of the mobile body 100. The control unit 130 includes one or more processors represented by a central processing unit (CPU), a memory device such as a semiconductor memory, an interface with an external device, and the like.

Instead of or in addition to the CPU, the processor may be a micro processing unit (MPU), a graphics processing unit (GPU), a neural processing unit (NPU), a quantum processing unit (QPU), or the like. The processor reads and executes a computer program stored in a memory device or the like, and achieves various functions of the control unit 130.

Some or all of the respective functions of the control unit 130 may be achieved by one or more circuits such as an application specific integrated circuit (ASIC) and a programmable logic device (PLD) including a field programmable gate array (FPGA).

The memory device may be, for example, a random access memory (RAM). The memory device stores a program to be executed by the processor, data to be used by the processor for processing and the like. A plurality of sets of processors, memory devices, and interfaces may be provided for the respective functions of the mobile body 100, and each set may be configured to be communicable with each other.

The control unit 130 acquires image information from the detection unit 114, user input information acquired by the operation unit 132, sound information from the sound input unit 133, and the like, and executes processing in accordance with each piece of information. The control unit 130 controls the motor 123a and the motor 123b of the traveling unit 125 to execute behavior control including traveling of the mobile body 100. The control unit 130 notifies the user or a person in the surroundings of information. For example, the control unit 130 controls display of images to be displayed on the front display unit 113 and the upper surface display unit 131 to notify the user of information. The control unit 130 may notify the user of information using light emission of the light emission unit 116. The control unit 130 may notify the user of information using sound output from the sound output unit 115. The control unit 130 may perform processing using a machine learning model for image recognition (for example, a deep neural network) on the image information from the detection unit 114. In addition, the control unit 130 may perform processing using the machine learning model for sound recognition (for example, the deep neural network) on sound information from the sound input unit 133.

The control unit 130 can recognize a feature point of the image captured by the detection unit 114 using the machine learning model. In addition, the control unit 130 can estimate a self-position of the mobile body 100 using the recognized feature point and map information stored in advance in the storage device 135. As a technique for estimating the self-position of the mobile body on the map, a known self-position estimation technique can be used. For example, an image of a scene in an environment is captured in advance, and an image capturing result or a feature point recognized from the image capturing result can be associated with a map and used as the map information. The control unit 130 can estimate the self-position by determining matching between the feature point in the image captured during traveling and a feature point of the map information, and can specify positions of surrounding travelable regions and obstacles. The map information stored in the storage device 135 may be represented, for example, in the form of an occupancy grid map. Each grid of the occupancy grid map may represent a region where the mobile body 100 can travel or a region of an obstacle. In a case where a current position of the mobile body 100 is arranged at the center of the occupancy grid map, a position of the obstacle viewed from the current position of the mobile body 100 can be specified.

In addition, the control unit 130 can recognize a person (for example, a pedestrian) and other traffic participants in the image using the machine learning model. The control unit 130 may recognize pedestrians and assign a unique identifier (ID) to each of the pedestrians. Then, the control unit 130 may trace (track) the pedestrian assigned the identifier in the subsequent images.

The upper surface display unit 131 may be a display device capable of displaying an image. The upper surface display unit 131 is provided on an upper surface of the upper end of the upper housing 112. The upper surface display unit 131 displays images, characters, and the like related to information that the user is to be notified of, based on the image information that has been acquired from the control unit 130. The upper surface display unit 131 displays, for example, an operation screen for receiving an operation from the user.

The operation unit 132 may be an input device such as a touch panel or a keyboard. The operation unit 132 is provided, for example, on a display surface of the upper surface display unit 131. The operation unit 132 receives an input from the user, and outputs the input to the control unit 130.

The sound input unit 133 may be a microphone or the like. The sound input unit 133 collects sound of the user and the surroundings of the mobile body 100, and outputs the collected sound to the control unit 130.

The GNSS sensor 134 receives a GNSS signal from a satellite, and detects the current position of the mobile body 100. Note that GNSS is an abbreviation for global navigation satellite system.

The storage device 135 includes a nonvolatile memory medium that stores various types of data. The storage device 135 may be a hard disk drive (HDD), a solid state drive (SSD), or the like. The storage device 135 may store programs to be executed by the processor, parameters necessary for executing the programs, data to be processed by the processor, and the like. The storage device 135 may store various parameters (for example, learned parameters of the deep neural network, hyperparameters, and the like) of the machine learning models for sound recognition and image recognition to be performed by the control unit 130. The storage device 135 can store map information of a space where the mobile body 100 travels.

The communication unit 136 communicates with an external device such as a communication terminal 140 of the user via wireless communication such as Wi-Fi or the 5th generation mobile communication system.

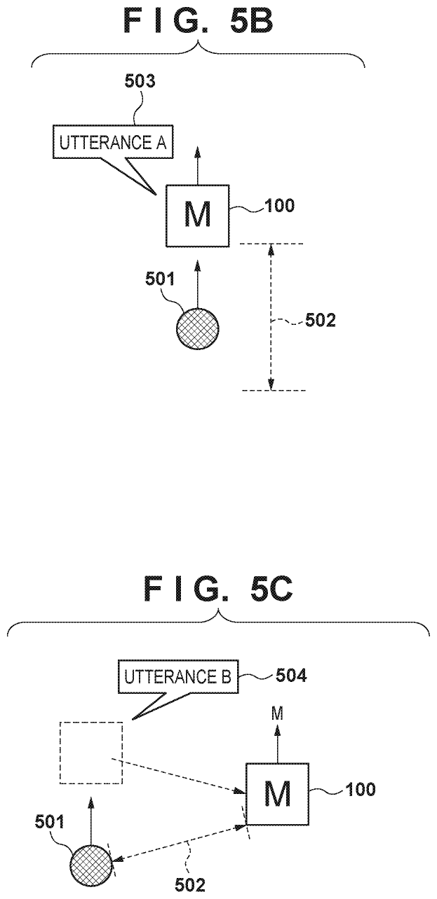

FIG. 4 is a functional block diagram illustrating functions of the control unit 130. The functions of the control unit 130 will be described with reference to FIG. 4.

The control unit 130 includes a person recognition unit 401, an environment recognition unit 402, an interaction control unit 403, an intention estimation unit 404, a route generation unit 405, and a drive control unit 406. The control unit 130 may implement the function of each unit of the control unit 130, for example, by reading a program from the storage device 135 and executing the program.

The person recognition unit 401 recognizes a pedestrian around the mobile body 100 from an image obtained by capturing the surroundings of the mobile body 100 by the detection unit 114. In a case where an image of a face or a whole body of a user (also referred to as a specific person) is captured and a feature value of the specific person is registered in advance, the person recognition unit 401 can recognize pedestrians in the image captured by the detection unit 114 using a machine learning model and recognize the specific person and the other pedestrians.

In addition, the person recognition unit 401 predicts a future position of the specific person (and each of the other pedestrians) with respect to the mobile body 100 using the image captured by the detection unit 114. A known technique can be used as a technique for predicting the future position of the pedestrian using the image. For example, when a time Δt has elapsed from the current time, the person recognition unit 401 outputs information indicating that a pedestrian A is located at a position (x, y) on a plane on which the mobile body 100 travels (for example, a position of the mobile body 100 is set as the origin). That is, the person recognition unit 401 can predict the positions, moving speeds, and future positions of the specific person and the other pedestrians.

In the present embodiment, the person recognition unit 401 recognizes an accompanying state of the specific person with respect to the mobile body. The accompanying state of the specific person with respect to the mobile body is recognized by a positional state between the mobile body and the specific person and a state of the moving speeds of the mobile body and the specific person.

The environment recognition unit 402 may recognize the surrounding environment from a plurality of images obtained by capturing various directions of the mobile body 100 using one or more trained machine learning models. From the captured images, the environment recognition unit 402 recognizes, for example, positions, sizes, shapes, and the like of a traveling road and a target object such as a road, a passage, a building, a wall, a store, a signboard, a sign, an obstacle, and a vehicle. The environment recognition unit 402 can recognize (acquire) information on the surrounding environment based on the recognition result from the images.

The environment recognition unit 402 may recognize (acquire) the positions, sizes, shapes, and the like of the traveling road and the target object around the mobile body 100 as information on the surrounding environment based on the self-position of the mobile body 100 and the map information.

The interaction control unit 403 generates a notification for the specific person in accordance with the recognition result of the person recognition unit 401 and the information on the surrounding environment from the environment recognition unit 402. The generated notification is output from the sound output unit 115, for example. The interaction control unit 403 may output the notification to the specific person by light emission of the front display unit 113 or the light emission unit 116 instead of or in addition to the notification by sound. In addition, an image representing a specific expression can be presented on the front display unit 113, and various expressions representing the state of the mobile body can be presented.

The interaction control unit 403 may store in advance notifications associated with the recognition results of the person recognition unit 401 and the information on the surrounding environment from the environment recognition unit 402, and select a notification in accordance with the recognition result or the like. Alternatively, the interaction control unit 403 may use a language model that outputs a notification in accordance with the recognition result of the person recognition unit 401 or the information on the surrounding environment from the environment recognition unit 402.

In the present embodiment, the interaction control unit 403 generates a notification depending on whether the accompanying state of the specific person with respect to the mobile body is an appropriate state (for example, an appropriate range). In the following description, as an example of the appropriate state, a case where the accompanying state of the specific person with respect to the mobile body has a range will be described as an example, but the appropriate state may be applied to a case where the accompanying state does not have a range. Details will be described later.

When recognizing behavior of the specific person for the notification by the person recognition unit 401, the interaction control unit 403 can further generate and output a notification in accordance with the recognition result.

The intention estimation unit 404 estimates an intention of the specific person by recognizing a gesture or a direction of a part of the body of the specific person based on an image obtained by capturing the surroundings of the mobile body 100. Alternatively, the intention estimation unit 404 estimates the intention of the specific person by recognizing the content of utterance of the specific person based on sound obtained by collecting the sound around the mobile body 100. For example, the intention estimation unit 404 can recognize a gesture or a direction of a part of the body of the specific person by inputting a captured image to a machine learning model. In addition, the intention estimation unit 404 can recognize the content of utterance of the specific person by inputting the collected sound to the machine learning model. The intention estimation unit 404 may estimate the intention of the specific person for a notification by recognizing behavior of the specific person for the notification.

The route generation unit 405 generates a route on which the mobile body 100 travels. When the specific person exists in a traveling region, the route generation unit 405 generates a route for following or leading (guiding) the specific person. During following, a route is generated such that the mobile body 100 travels slightly away in the rear periphery of the specific person. During leading, a route is generated such that the mobile body 100 travels slightly away in the front periphery of the specific person while predicting movement of the specific person. The route generation unit 405 may generate a route such that other pedestrians that hinder the movement of the specific person do not excessively approach the specific person during leading.

The drive control unit 406 controls the motor 123a and the motor 123b, for example, to cause the mobile body 100 to travel along the route generated by the route generation unit 405. The drive control unit 406 may rotate the motor 123a and the motor 123b in opposite directions to each other to cause the mobile body 100 to perform a spin turn or a pivot turn (also referred to as on-the-spot turn) without moving. Note that the drive control unit 406 may cause the mobile body 100 to turn by a turn other than the spin turn or the pivot turn.

### Outline of State Optimization

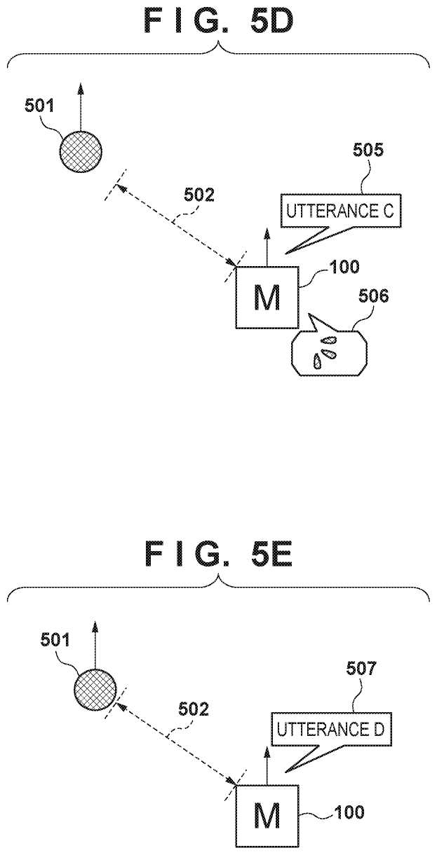

Next, state optimization according to the present embodiment will be described with reference to FIGS. 5A to 5E.

FIG. 5A schematically illustrates a state in which the mobile body 100 and a specific person 501 exist on a plane on which the mobile body 100 travels. The plane on which the mobile body 100 travels is, for example, a region where a pedestrian walks and includes a sidewalk, an open space, a floor in a building, and the like, and may include a roadway. For example, the mobile body 100 autonomously moves in the region where a pedestrian walks while leading (guiding) the specific person at least temporarily.

While leading the specific person 501, the person recognition unit 401 recognizes the specific person and predicts a moving speed and a moving direction of the specific person. In addition, the person recognition unit 401 recognizes an accompanying state of the specific person 501 with respect to the mobile body 100. In the example illustrated in FIG. 5A, the mobile body 100 and the specific person 501 are separated from each other by a distance 502. The distance 502 is included in an appropriate distance range in movement of the mobile body 100 and the specific person. In addition, each of the mobile body 100 and the specific person 501 moves forward at a speed equal to or less than a predetermined threshold. It is assumed that a difference in the moving speed between the mobile body 100 and the specific person 501 is substantially zero.

In this case, for example, the interaction control unit 403 determines that the accompanying state of the specific person 501 with respect to the mobile body 100 is appropriate since the moving speed of the specific person 501 is equal to or less than the predetermined threshold and the distance 502 between the mobile body 100 and the specific person 501 is within the appropriate distance range.

FIG. 5B illustrates a state in which the moving speed of the specific person 501 is increased after FIG. 5A. In the example illustrated in FIG. 5B, the distance between the mobile body 100 and the specific person 501 is shorter than the distance 502, and is out of the appropriate distance range between the mobile body 100 and the specific person 501. The mobile body 100 moves forward at a speed equal to or lower than a first threshold (a lower limit of the appropriate range), but the specific person 501 moves forward at a speed higher than a second threshold (an upper limit of the appropriate range).

In this case, for example, the interaction control unit 403 determines that the accompanying state of the specific person 501 with respect to the mobile body 100 is not appropriate since the moving speed of the specific person 501 exceeds the second threshold and the distance between the mobile body 100 and the specific person 501 is out of the appropriate distance range. The interaction control unit 403 outputs a request for behavior of the specific person 501 to set the accompanying state of the specific person 501 in the appropriate range.

For example, the interaction control unit 403 outputs an utterance 503 requesting the specific person 501 to “walk slowly since movement at a speed higher than the current speed is not possible”. In this utterance 503, “walk slowly” is a request to decrease the moving speed of the specific person 501. In addition, the request may include, in addition to a request for the specific person, an expression indicating a reason why the accompanying state cannot be maintained (for example, “movement at a speed higher than the current speed is not possible”). In a case where the safety is deteriorated due to approach between the specific person and the mobile body, or in a case where the mobile body cannot catch up with the specific person, it is possible to convey an intuitive request for improvement of the accompanying state and to optimize the accompanying state. In addition, by indicating the reason why the accompanying state cannot be maintained, the specific person can further understand a method for maintaining the accompanying state.

In a case where the specific person 501 moves away from the mobile body 100, the interaction control unit 403 can output, to the specific person 501, a request to approach the mobile body 100.

FIG. 5C illustrates an operation in a case where the accompanying state does not fall within the appropriate range even after the request is output from the mobile body 100.

The interaction control unit 403 determines that a situation in which the accompanying state of the specific person 501 is not in the appropriate range has not been improved within a predetermined time after the output of the request for the behavior of the specific person. This may be based on the fact that the distance between the mobile body 100 and the specific person 501 is shorter than the distance 502. After this determination, the route generation unit 405 generates a route for moving the mobile body 100 to a traveling position where the accompanying state of the specific person falls within the appropriate range. The route generation unit 405 determines, for example, the traveling position where the distance 502 can be secured on the right side of the specific person 501, and moves the mobile body 100.

At this time, the interaction control unit 403 notifies the specific person of the traveling position of the mobile body before moving the mobile body 100 to the right side of the specific person 501. For example, the interaction control unit 403 outputs a notification (an utterance 504) such as “movement to the side will be performed not to hinder walking of the specific person”. Here, the expression “movement to the side will be performed” is an expression indicating a relative position of the mobile body 100 from the specific person 501. Note that the content to be notified by sound may be a linguistic expression such as “movement to the side will be performed”, or may be a non-linguistic expression such as a notification by sound that does not depend on words. As described above, in a case where the situation is not improved with the request to the specific person, it is possible to avoid continuation of a low safety state or an uncomfortable state, for example, as the mobile body improves the accompanying state to the appropriate range by itself. In addition, the specific person is notified before the mobile body changes the traveling position, and thus, is not confused by the change in the position of the mobile body.

FIG. 5D illustrates a case where, after the accompanying state of the specific person 501 is improved to the appropriate range, the moving speed of the specific person 501 increases so that the accompanying state is not in the appropriate range again.

In this case, the interaction control unit 403 outputs an utterance 505 requesting the specific person 501 to “walk slowly” again. The mobile body 100 may display an expression 506 indicating that the mobile body 100 is in a high output state by light emission of the front display unit 113 or the light emission unit 116. The expression (the expression 506) that the mobile body 100 is in the high output state may include, for example, an expression that the accompanying state is not appropriate or difficult, such as an expression of sweating or an expression of breathing hard. By causing the mobile body 100 to express a state that a person has, it is possible to give a sense of closeness to the mobile body 100.

FIG. 5E illustrates a case where the accompanying state of the specific person 501 is improved to the appropriate range after the request by the interaction control unit 403. When the accompanying state is optimized, the interaction control unit 403 notifies the specific person 501 of the traveling position of the mobile body 100 and an expression of gratitude (an utterance 507). The traveling position of the mobile body is notified to make the specific person 501 be more aware of the presence of the mobile body 100 and to maintain the accompanying state.

As described above, when it is determined that the accompanying state with respect to the specific person 501 is not in the appropriate range, the mobile body 100 outputs the request for the behavior of the specific person to set the accompanying state of the specific person in the appropriate range. In this manner, it is possible to bring the movement of the mobile body and the specific person into the appropriate state.

### Series of Operations of State Optimization

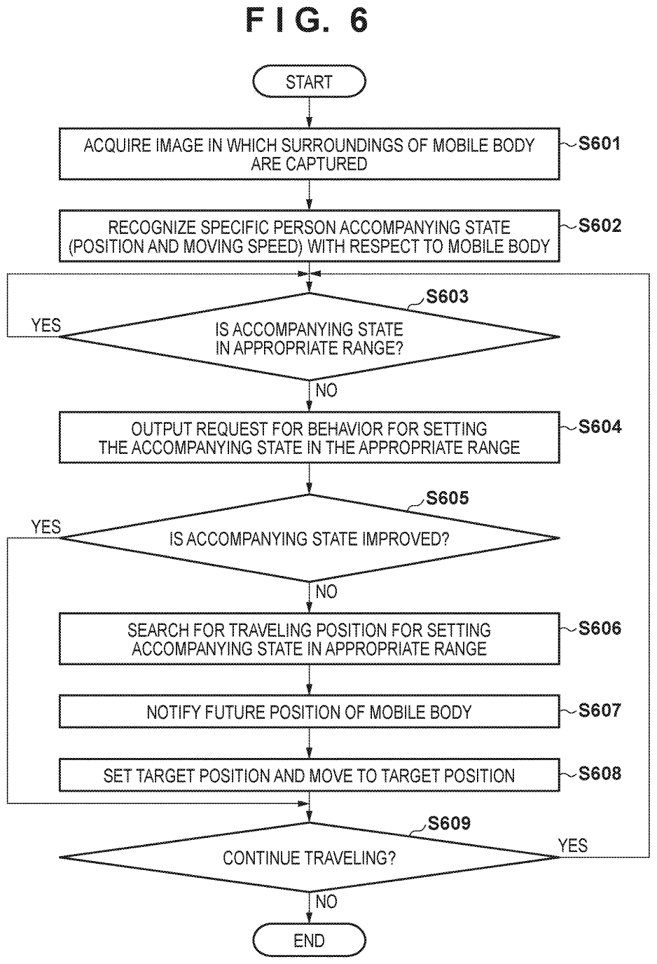

A series of operations of state optimization executed by the control unit 130 will be described with reference to FIG. 6. Note that this series of operations is implemented as the control unit 130 executes a program stored in the storage device 135 and each unit in the control unit 130 executes processing. In addition, this series of operations can be executed when the mobile body 100 autonomously travels.

In S601, the person recognition unit 401 acquires an image obtained by capturing the surroundings of the mobile body 100 from the detection unit 114. At this time, the environment recognition unit 402 may also acquire the image.

In S602, the person recognition unit 401 recognizes an accompanying state of a specific person with respect to the mobile body 100. As described above, the accompanying state of the specific person with respect to the mobile body is recognized by a positional state between the mobile body and the specific person and a state of the moving speeds of the mobile body and the specific person.

In S603, the interaction control unit 403 determines whether the recognized accompanying state is in an appropriate range. For example, the interaction control unit 403 determines that the accompanying state of the specific person is not in the appropriate range in at least one of a case where a difference between a moving speed of the specific person and a moving speed of the mobile body is larger than a speed threshold and a case where a distance between the specific person and the mobile body is not included in a certain distance width. The interaction control unit 403 causes the processing to proceed to S604 when it is determined that the accompanying state of the specific person is not within the appropriate range. Otherwise, the processing returns to S603.

According to such determination, for example, in a case where the distance between the mobile body and the specific person is shortened or widened, it is possible to determine that the accompanying state of the specific person is not appropriate. That is, it is possible to optimize the accompanying state in a case where the safety is deteriorated due to approach between the specific person and the mobile body or in a case where the mobile body cannot catch up with the specific person.

In S604, the interaction control unit 403 outputs a request for behavior for setting the accompanying state in the appropriate range. As described above, the interaction control unit 403 outputs the utterance 503 requesting the specific person 501 to “walk slowly since movement at a speed higher than the current speed is not possible”.

In S605, the interaction control unit 403 determines whether the accompanying state has been improved. For example, in a case where the distance between the mobile body 100 and the specific person 501 is out of the appropriate range, the interaction control unit 403 determines that the accompanying state is not improved, and causes the processing to proceed to S606. When it is determined that the accompanying state has been improved, the interaction control unit 403 causes the processing to proceed to S609.

In the example illustrated in FIG. 6, the case where the processing proceeds to S609 when it is determined that the accompanying state has been improved has been described as an example. However, as described above with reference to FIG. 5E, the interaction control unit 403 may notify the specific person 501 of a traveling position of the mobile body 100 and the expression of gratitude when the accompanying state is optimized.

In S606, the route generation unit 405 searches for the traveling position for setting the accompanying state of the specific person in the appropriate range. In S607, the interaction control unit 403 notifies a future position of the mobile body 100 before moving to the searched traveling position. For example, the interaction control unit 403 outputs a notification (an utterance 504) such as “movement to the side will be performed not to hinder walking of the specific person”.

In S608, the route generation unit 405 sets the searched traveling position as a target position, and the drive control unit 406 moves the mobile body 100 to the target position.

In S609, the control unit 130 determines whether to continue traveling of the mobile body 100. In a case where it is determined to continue traveling, the processing returns to S603, and otherwise, the processing ends.

In the above-described embodiment, the exemplary case where the control device is the control unit 130 of the mobile body 100 has been described. However, the control device may be included in, for example, an information processing server present outside the mobile body 100. In this case, the control device may perform a part or all of the processing performed by the above-described control unit 130 while communicating with the mobile body 100. That is, the present embodiment is also applicable to a case where the mobile body 100 is remotely controlled from a device separate from the mobile body 100.

As described above, in the above-described embodiment, the person recognition unit 401 recognizes the accompanying state of the specific person 501 with respect to the mobile body 100 using the image obtained by capturing the surroundings of the mobile body 100, and the interaction control unit 403 determines whether the accompanying state of the specific person is in the appropriate range. When it is determined that the accompanying state of the specific person 501 is not in the appropriate range, the interaction control unit 403 outputs the request for the behavior of the specific person 501 to set the accompanying state of the specific person 501 in the appropriate range. In this manner, it is possible to bring the movement of the mobile body and the specific person into the appropriate state.

### Summary of Embodiment

### Configuration 1

A control method of a mobile body that autonomously moves together with a specific person, the control method comprising:
recognizing an accompanying state of the specific person with respect to the mobile body using an image obtained by capturing surroundings of the mobile body;
determining whether the accompanying state of the specific person is a predetermined state that is an appropriate state; and
outputting a request for behavior of the specific person to bring the accompanying state of the specific person into the appropriate state when it is determined that the accompanying state of the specific person is not the appropriate state.

In this embodiment, it is possible to bring the movement of the mobile body and the specific person into the appropriate state.

### Configuration 2

The control method according to configuration 1, wherein the determining includes determining that the accompanying state of the specific person is not the appropriate state in at least one of a case where a difference between a moving speed of the specific person and a moving speed of the mobile body is larger than a speed threshold and a case where a distance between the specific person and the mobile body is not included in a certain distance width.

In this embodiment, it is possible to optimize the accompanying state in a case where the safety is deteriorated due to approach between the specific person and the mobile body or in a case where the mobile body cannot catch up with the specific person.

### Configuration 3

The control method according to configuration 1, wherein the request for the behavior of the specific person includes at least one of a request for decreasing a moving speed of the specific person and a request for approaching the mobile body.

In this embodiment, in a case where the safety is deteriorated due to approach between the specific person and the mobile body, or in a case where the mobile body cannot catch up with the specific person, it is possible to convey an intuitive request for improvement of the accompanying state and to optimize the accompanying state.

### Configuration 4

The control method according to configuration 3, wherein the request for the behavior of the specific person further includes an expression indicating a reason why it is not possible to maintain the accompanying state.

In this embodiment, by indicating the reason why the accompanying state cannot be maintained, the specific person can further understand a method for maintaining the accompanying state.

### Configuration 5

The control method according to configuration 3, wherein the outputting the request for the behavior of the specific person includes displaying an expression indicating that the mobile body is in a high-output state on a display device.

In this embodiment, by causing the mobile body 100 to express a state that a person has, it is possible to give a sense of closeness to the mobile body 100.

### Configuration 6

The control method according to configuration 1, further comprising moving to a traveling position where the accompanying state of the specific person becomes the appropriate state in a case where the accompanying state of the specific person is not improved to the appropriate state within a predetermined time after the specific person moves behind the mobile body and the request for the behavior of the specific person is output.

In this embodiment, in a case where the situation is not improved with the request to the specific person, it is possible to avoid continuation of a low safety state or an uncomfortable state, for example, as the mobile body improves the accompanying state to the appropriate state by itself.

### Configuration 7

The control method according to configuration 6, further comprising notifying the specific person of the traveling position of the mobile body before movement to the traveling position where the accompanying state of the specific person becomes the appropriate state.

In this embodiment, the specific person is notified before the mobile body changes the traveling position, and thus, is not confused by the change in the position of the mobile body.

### Configuration 8

The control method according to configuration 7, wherein the notifying the specific person of the traveling position of the mobile body includes performing the notification using an expression indicating a relative position of the mobile body from the specific person.

In this embodiment, the specific person can intuitively understand the movement of the mobile body.

### Configuration 9

The control method according to configuration 1, wherein the request for the behavior of the specific person is repeatedly output in a case where the accompanying state of the specific person is not improved to the appropriate state within a predetermined time after the request for the behavior of the specific person is output.

In this embodiment, it is possible to increase the opportunity for the specific person to grasp the request by the repetition.

### Configuration 10

The control method according to configuration 1, further comprising notifying the specific person of a traveling position of the mobile body and an expression of gratitude in a case where the accompanying state of the specific person is improved to the appropriate state within a predetermined time after the request for the behavior of the specific person is output.

In this embodiment, the traveling position of the mobile body is notified to make the specific person be more aware of the presence of the mobile body and to maintain the accompanying state.

### Configuration 11

The control method according to configuration 1, wherein the outputting the request includes outputting the request for the behavior of the specific person when autonomous movement is performed in a region where a pedestrian walks while following, leading, or guiding the specific person at least temporarily.

In this embodiment, when the mobile body leads the specific person, it is possible to bring the movement of the mobile body and the specific person into the appropriate state.

The disclosure is not limited to the foregoing embodiments, and various variations/changes are possible within the spirit of the disclosure.

What is claimed is:

1. A control method of a mobile body that autonomously moves together with a specific person, the control method comprising:
recognizing an accompanying state of the specific person with respect to the mobile body using an image obtained by capturing surroundings of the mobile body;
determining whether the accompanying state of the specific person is a predetermined state that is an appropriate state; and
outputting a request for behavior of the specific person to bring the accompanying state of the specific person into the appropriate state when it is determined that the accompanying state of the specific person is not the appropriate state.

2. The control method according to claim 1, wherein the determining includes determining that the accompanying state of the specific person is not the appropriate state in at least one of a case where a difference between a moving speed of the specific person and a moving speed of the mobile body is larger than a speed threshold and a case where a distance between the specific person and the mobile body is not included in a certain distance width.

3. The control method according to claim 1, wherein the request for the behavior of the specific person includes at least one of a request for decreasing a moving speed of the specific person and a request for approaching the mobile body.

4. The control method according to claim 3, wherein the request for the behavior of the specific person further includes an expression indicating a reason why it is not possible to maintain the accompanying state.

5. The control method according to claim 3, wherein the outputting the request for the behavior of the specific person includes displaying an expression indicating that the mobile body is in a high-output state on a display device.

6. The control method according to claim 1, further comprising moving to a traveling position where the accompanying state of the specific person becomes the appropriate state in a case where the accompanying state of the specific person is not improved to the appropriate state within a predetermined time after the specific person moves behind the mobile body and the request for the behavior of the specific person is output.

7. The control method according to claim 6, further comprising notifying the specific person of the traveling position of the mobile body before movement to the traveling position where the accompanying state of the specific person becomes the appropriate state.

8. The control method according to claim 7, wherein the notifying the specific person of the traveling position of the mobile body includes performing the notification using an expression indicating a relative position of the mobile body from the specific person.

9. The control method according to claim 1, wherein the request for the behavior of the specific person is repeatedly output in a case where the accompanying state of the specific person is not improved to the appropriate state within a predetermined time after the request for the behavior of the specific person is output.

10. The control method according to claim 1, further comprising notifying the specific person of a traveling position of the mobile body and an expression of gratitude in a case where the accompanying state of the specific person is improved to the appropriate state within a predetermined time after the request for the behavior of the specific person is output.

11. The control method according to claim 1, wherein the outputting the request includes outputting the request for the behavior of the specific person when autonomous movement is performed in a region where a pedestrian walks while following, leading, or guiding the specific person at least temporarily.

12. A control device of a mobile body that autonomously moves together with a specific person, the control device comprising:
a recognition unit configured to recognize an accompanying state of the specific person with respect to the mobile body using an image obtained by capturing surroundings of the mobile body;
a determination unit configured to determine whether the accompanying state of the specific person is a predetermined state that is an appropriate state; and
an output unit configured to output a request for behavior of the specific person to bring the accompanying state of the specific person into the appropriate state when it is determined that the accompanying state of the specific person is not the appropriate state.

13. A mobile body that autonomously moves together with a specific person, the mobile body comprising:
a recognition unit configured to recognize an accompanying state of the specific person with respect to the mobile body using an image obtained by capturing surroundings of the mobile body;
a determination unit configured to determine whether the accompanying state of the specific person is a predetermined state that is an appropriate state; and
an output unit configured to output a request for behavior of the specific person to bring the accompanying state of the specific person into the appropriate state when it is determined that the accompanying state of the specific person is not the appropriate state.

14. A non-transitory computer readable storage medium storing a program for causing a computer to execute a control method of a mobile body that autonomously moves together with a specific person, the control method comprising:
recognizing an accompanying state of the specific person with respect to the mobile body using an image obtained by capturing surroundings of the mobile body;
determining whether the accompanying state of the specific person is a predetermined state that is an appropriate state; and
outputting a request for behavior of the specific person to bring the accompanying state of the specific person into the appropriate state when it is determined that the accompanying state of the specific person is not the appropriate state.
